(19) United States
(12) Patent Application Publication
(10) Pub. No.: US 2015/0120334 A1
(43) Pub. Date: Apr. 30, 2015

(54) Law Enforcement Database of Active Insurance Information

(71) Applicant: Cortney Jones, Riverdale, IL (US)

(72) Inventor: Cortney Jones, Riverdale, IL (US)

(21) Appl. No.: 14/068,152

(22) Filed: Oct. 31, 2013

(51) Int. Cl. G06Q 40/08

(52) U.S. Cl. CPC G06Q 40/08
USPC 705/4

(57) ABSTRACT

A system and method for verifying the status of an insured automobile insurance are disclosed. In particular, a law enforcement officer with a smart phone or tablet takes a picture of a motorist's insurance card while at a traffic stop. The picture is then transmitted to an insurance policy server hosting a collection of records each with insurance information. The policy number is extracted from the picture and a corresponding record is retrieved from the insurance policy server. The status of the policy, which is contained in the record, is then transmitted to the law enforcement officer's smart phone or tablet computer.

### CROSS REFERENCE TO RELATED APPLICATIONS

None

### FIELD OF THE DISCLOSURE

The present disclosure generally relates to automobile insurance, and more particularly to a database of active automobile insurance information accessible by wireless network for use by law enforcement officers.

### BACKGROUND

Most states require that motorists obtain liability insurance to pay for any accidents that they are involved in that are deemed their fault. To insure compliance, law enforcement will request proof of insurance at every routine traffic stop. Certain states, such as Maryland, have assembled statewide databases of insurance information. However, this information is restricted to that particular state—it is of little use when an out-of-state driver is stopped. Accordingly, in many cases, law enforcement and other businesses that need to verify insurance are still presently restricted in merely scanning an insurance card, with no way to ensure that a presented insurance card is valid. Therefore, a need exists for a national database of insurance information.

### Objects of the Disclosed System, Method, and Apparatus

Accordingly, it is an object of this disclosure to provide a national database of insurance information.

Another object of this disclosure is to provide a national database of insurance information that accommodates differences in state systems.

Another object of this disclosure is to provide a wirelessly accessible national database of insurance information.

Other advantages of this disclosure will be clear to a person of ordinary skill in the art. It should be understood, however, that a system or method could practice the disclosure while not achieving all of the enumerated advantages, and that the protected disclosure is defined by the claims.

### SUMMARY OF THE DISCLOSURE

An insurance verification system for motor vehicle insurance is disclosed. The insurance verification system includes an insurance policy server that stores a plurality of records, each corresponding to an insurance policy. Ideally, every motor vehicle insurance policy will be included in the assembled motorist insurance database (“MID”). The insurance policy server includes a network interface that is coupled to a network, such as the Internet. A remote computer system, such as a smart phone or a tablet computer, is used by a person that desires to validate that an insurance policy is active. The remote computer system transmits an insurance policy identifier to the insurance policy server, which then retrieves the status of the identified insurance policy and transmits it back to the remote computer system.

Examples of an insurance policy identifier include, for example, a license plate number, an insurance policy number, an insurance policy number combined with an underwriting insurance company identifier, a vehicle identification number, and a driver's license number.

In one embodiment of the disclosed system, the remote computer system includes a camera that takes a picture of a motor vehicle insurance card or a vehicle's license plate. The image of the insurance card is then transmitted to the insurance policy server where the insurance policy identifier can be extracted. Alternatively, the insurance policy identifier can be extracted by the remote computer system.

### BRIEF DESCRIPTION OF THE DRAWINGS

Although the characteristic features of this disclosure will be particularly pointed out in the claims, the invention itself, and the manner in which it may be made and used, may be better understood by referring to the following description taken in connection with the accompanying drawings forming a part hereof, wherein like reference numerals refer to like parts throughout the several views and in which:

FIG. 1 is a system diagram of an insurance verification system constructed in accordance with this disclosure;

FIG. 2 is a flowchart illustrating a process by which a device can be authorized to access an insurance validation database in accordance with this disclosure;

FIG. 3 is a flowchart illustrating process by which an insurance status can be retrieved from an insurance validation database in accordance with this disclosure; and

FIG. 4 depicts various remote computer systems that can be used with the disclosed system and method.

### DETAILED DESCRIPTION

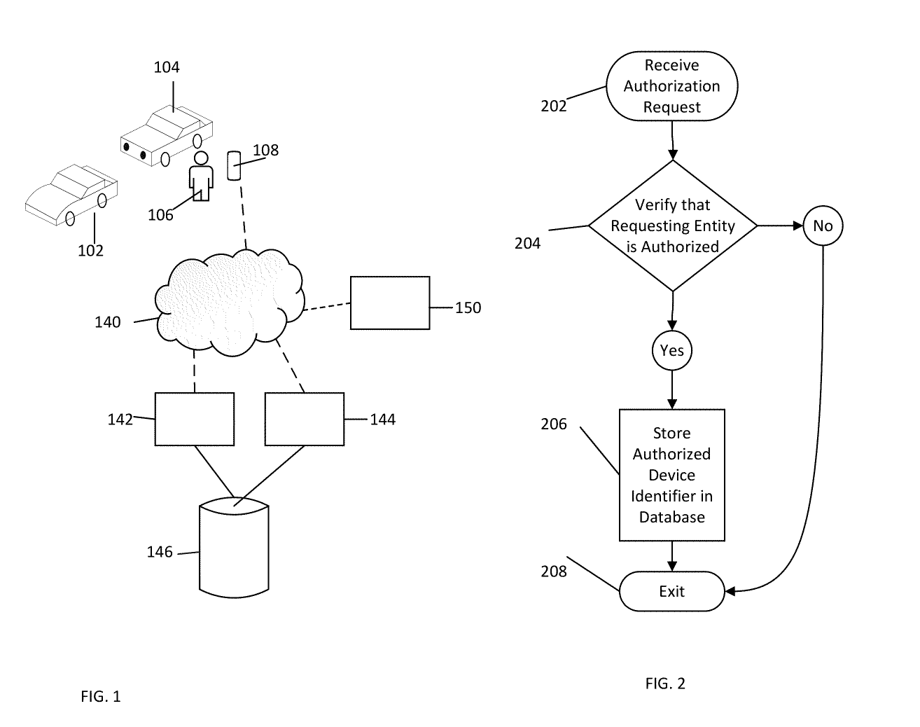

Turning to the Figures and to FIG. 1 in particular, a system for validating an insurance policy is disclosed. As depicted, the system is used to validate the insurance policy of a motor vehicle 102 involved in a traffic stop. However, the disclosed system can be used in a variety of settings, including by a networked computer. For example, the disclosed system could be used by a courier company to verify that its employees have adequate insurance, or by a private airport to ensure that anyone who seeks access to the airport grounds has adequate insurance.

As depicted a law enforcement vehicle 104 has pulled over a motor vehicle 102. A police officer 106 uses a smart phone 108, laptop computer (not shown) or tablet (not shown) to transmit an insurance policy identifier to an insurance policy server 142 over a wireless network 140. The wireless network can be connected to the Internet, but this is not required to practice the invention. As explained herein, once the insurance policy identifier is transmitted to the insurance policy server 142, a status corresponding to the identified insurance policy is retrieved and returned to the requesting device (in this case the smart phone 108).

In addition, FIG. 1 displays an authorization server 144 and a database 146. The authorization server 144 operates to authorize a device the first time that it is used. The database 146 stores a motorist insurance database (“MID”) as well as an authorized device database. It should be noted that while the database 146 is depicted as a single unit, it could comprise multiple units and still be within scope of the disclosed invention.

One potential user of this information is one or more state's Department of Motor Vehicles (“DMV”). In FIG. 1, a DMV is depicted by element 150. It should be noted that a DMV 150 can comprise more than a single computer as depicted, and could also comprise, for example, multiple computers, databases, and other infrastructure. A DMV 150 can use this to validate compliance with insurance laws, when, for example, issuing license plates for a vehicle—if the vehicle does not have an active insurance policy, the DMV 150 can refuse to issue the license plates, and instead, for example, automatically generate a letter to the citizen seeking insurance stating the s/he must first acquire insurance for the vehicle.

One issue that arises with compiling a database of insurance information is restricting access to those who actually require access. In particular, given that the MID will include personal identifying information of potentially every motorist in the country, there would be an enormous incentive to gain illicit access to the database for purposes of identity theft, etc. Accordingly, limiting access to the database to those that require it is advantageous.

One way to accomplish this objective would be to assemble an authorized device database. The database would contain records each with an identifier representing a device that is authorized to access the MID. Examples of suitable identifiers include, for example, the Media Access Control (“MAC”) address of a device, or a Universally Unique Identifier (“UUID”) stored on the device.

A method for authorizing a device to access the MID is disclosed in FIG. 2. In particular, in step 202 an authorization request is received by the authorization server 144. The authorization server 144 then extracts an entity identifier from the authorization request and verifies that the entity is authorized to access the MID in step 204. If the entity is authorized to access the MID, a device identifier is stored in the authorized device database in step 206. The process is then exited in step 208. Returning to step 204, if the entity seeking access to the MID is not authorized, the process exits in step 208.

The MID itself could comprise a number of records each corresponding to a particular insurance policy. Each record in the MID could include an insurance policy number, an identifier that indicates which insurance company wrote the policy, and a status of the insurance policy. In addition, each record of the MID could also include the name of the insured, the address of the insured, a description of the insured vehicle, the vehicle identification number, the insured's driver's license number, the license plate number of the insured vehicle, the coverages of the policy, and the term of the policy.

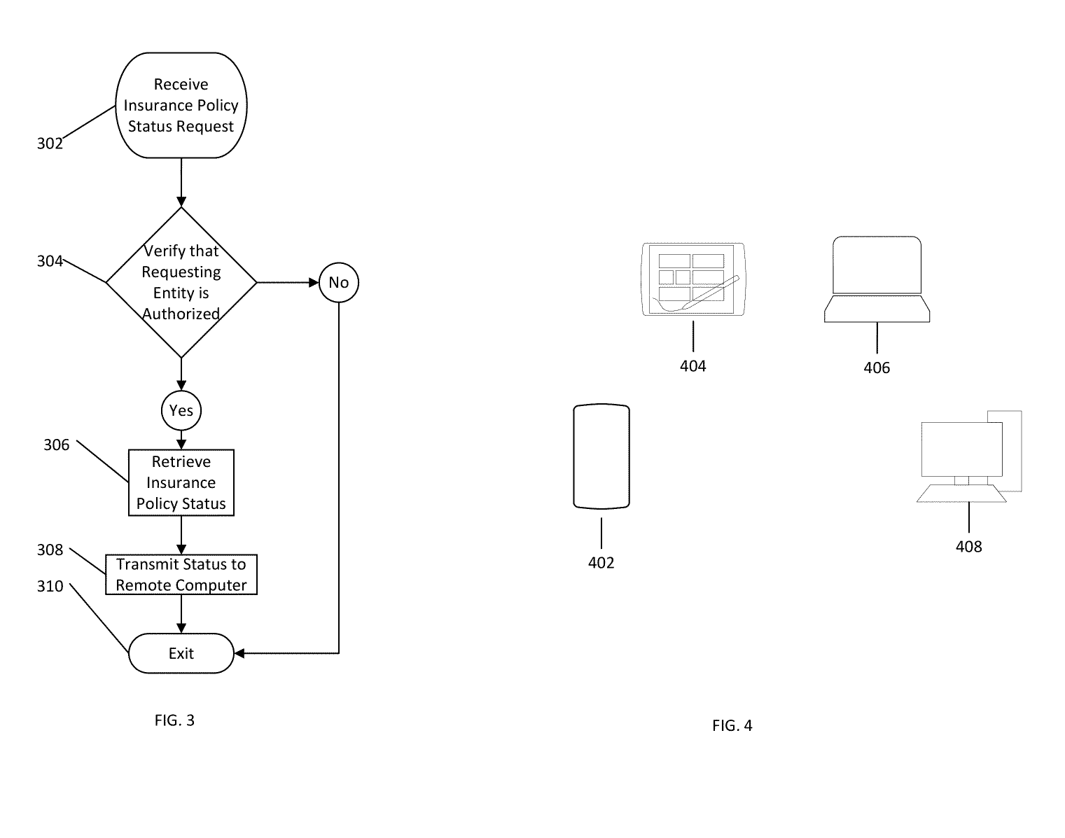

A method for retrieving an insurance policy status corresponding to an insurance policy is disclosed in FIG. 3. In step 302 an insurance policy status request is received by the insurance policy server 142 in step 302. In step 304, a check is made to determine if the entity that is requesting access to the MID is authorized. This step is accomplished by checking an entity identifier within the insurance policy status request against the authorized entity database assembled using the process of FIG. 2. If the entity is authorized to access the MID, execution proceeds to step 306, where a status corresponding to an identified insurance policy is retrieved from the MID.

The insurance policy can be identified in a number of ways, including by a nationally unique insurance identifier. However, given the present state of the insurance industry, it is unlikely that a national system will be developed that assigns each policy a unique identifier. Accordingly, another way to identify the insurance policy would be through the combination of an underwriting insurance company identifier and a policy identifier that is unique to the particular underwriting insurance company; e.g., the policy number assigned by the underwriting insurance company. Other ways to identify the insurance policy would be through the license plate number of the insured vehicle, the driver's license number of the insured, the vehicle identification number of the insured vehicle, or other identifies that can identify a particular insurance policy.

Alternatively, included in the insurance policy status request can be a complete image of an insurance card taken by a camera disposed in the remote computer system 108. The required insurance policy identifier can be extracted by the insurance policy server 142. Alternatively, the remote computer system 108 can extract the insurance policy identifier from the image prior to transmitting the insurance policy request to the insurance policy server 142.

Once the status of the requested insurance policy is retrieved, it is transmitted to the requesting remote computer 108 in step 308, which then displays the status to a user. In step 310, the process is exited. Returning to step 304, if the entity requesting insurance policy information is not authorized to access the MID, the process is exited in step 310.

Turning to FIG. 4, a number of potential remote computer systems are depicted. A smart phone 402 and a tablet device 404 are suitable for use by mobile professionals, such as law enforcement professionals. A laptop computer 406 and a desktop computer 408 are suitable for use by those seeking access to the MID from a fixed location, such as, for example, an operator of a private airport.

The foregoing description of the disclosure has been presented for purposes of illustration and description, and is not intended to be exhaustive or to limit the disclosure to the precise form disclosed. The description was selected to best explain the principles of the present teachings and practical application of these principles to enable others skilled in the art to best utilize the disclosure in various embodiments and various modifications as are suited to the particular use contemplated. It is intended that the scope of the disclosure not be limited by the specification, but be defined by the claims set forth below. In addition, although narrow claims may be presented below, it should be recognized that the scope of this invention is much broader than presented by the claim(s). It is intended that broader claims will be submitted in one or more applications that claim the benefit of priority from this application. Insofar as the description above and the accompanying drawings disclose additional subject matter that is not within the scope of the claim or claims below, the additional inventions are not dedicated to the public and the right to file one or more applications to claim such additional inventions is reserved.

What is claimed is:

1. A motor vehicle insurance verification system comprising:
i) an insurance policy server;
ii) a database accessible by the insurance policy server and including a plurality of records, wherein each record includes at least an insurance policy identifier and a status;
iii) the insurance policy server further comprising a first network interface;
iv) a remote computer system including a second network interface and an input device;
v) the first network interface of the remote computer system being adaptively coupled to the insurance policy server through a wireless network; and
vi) wherein the remote computer system is adapted to accept an insurance policy identifier and transmit the insurance policy identifier to the insurance policy server through the wireless network, and wherein the insurance policy server is adapted to retrieve the insurance policy status from the database and transmit the insurance policy status to the remote computer system through the wireless network in response to the insurance policy identifier.

2. The motor vehicle insurance verification system of claim 1 wherein the remote computer system is a smart phone or tablet computer.

3. The motor vehicle insurance verification system of claim 1 wherein the input device is a camera integrated into the remote computer system, the camera being adapted to photograph an insurance card thereby creating an image, and wherein the remote computer system is adapted to transmit the image to the insurance policy server.

4. The motor vehicle insurance verification system of claim 1 wherein each record further includes a Vehicle Identification Number and wherein the Vehicle Identification Number is the insurance policy identifier.

5. The motor vehicle insurance verification system of claim 1 wherein each record further includes an insured's name and address.

6. The motor vehicle insurance verification system of claim 1 wherein the insurance policy identifier is an insurance policy number.

7. The motor vehicle insurance verification system of claim 1 wherein each record further includes a driver's license number and wherein the driver's license number is the insurance policy identifier.

8. The motor vehicle insurance verification system of claim 1 wherein each record further includes a license plate number and wherein the license plate number is the insurance policy identifier.

9. A method for verifying motor vehicle insurance comprising the steps of:
i) accepting an insurance policy identifier at a remote computer system;
ii) transmitting the insurance policy identifier through a wireless network;
iii) receiving the insurance policy identifier at an insurance policy server;
iv) retrieving an insurance policy status from a database accessible by the insurance policy server corresponding to the insurance policy identifier; and
v) transmitting the insurance policy status to the remote computer system.

10. The method of claim 9 wherein the insurance policy identifier is an image of an insurance card.
